(19) United States
(12) Patent Application Publication
(10) Pub. No.: US 2023/0295772 A1
(43) Pub. Date: Sep. 21, 2023

(54) ALLOY AND COMPOSITE FORMATION BY REACTIVE SYNTHESIS DURING ADDITIVE MANUFACTURING

(71) Applicant: Wisconsin Alumni Research Foundation, Madison, WI (US)

(72) Inventors: John Harry Perepezko, Madison, WI (US); Dan Thoma, Fitchburg, WI (US); MD Zahabul Islam, Bowling Green, OH (US); Longfei Liu, Verona, WI (US)

(21) Appl. No.: 18/183,466

(22) Filed: Mar. 14, 2023

Related U.S. Application Data
(60) Provisional application No. 63/269,350, filed on Mar. 15, 2022.

(51) Int. Cl. C22C 1/05; B22F 10/28; B33Y 10/00; C22C 32/00; B22F 10/64; B28B 1/00

(52) U.S. Cl. CPC C22C 1/05; B22F 10/28; B33Y 10/00; C22C 32/0073; B22F 10/64; C22C 32/0078; B28B 1/001; B22F 2302/20; B22F 2301/40; B22F 2301/35; B22F 2998/10; B22F 2999/00

(57) ABSTRACT

Methods for forming metal alloys, including refractory intermetallic alloys, and ceramic composites using reactive synthesis during additive manufacturing (AM) are provided. In the AM processes, an exothermic reaction path is used, such that the heat from the reaction drives the synthesis reaction. Using this approach, component powders that are readily available from commercial vendors or easily synthesized using conventional methods are mixed in selected amounts and subsequently reacted via AM to produce metal alloys or ceramic composites.

### CROSS REFERENCE TO RELATED APPLICATIONS

The present application claims priority to U.S. provisional patent application No. 63/269,350 that was filed Mar. 15, 2022, the entire contents of which are incorporated herein by reference.

### BACKGROUND

Refractory metal alloys (RMAs) offer an attractive option to extend operational capability beyond what is currently available with nickel (Ni)-based superalloys to provide enhanced efficiency and power generation in gas turbines. However, the processing of the RMAs to manufacture dimensionally controlled shapes—such as a turbine airfoil—in a commercially cost-effective way is challenging. The application of traditional casting processes for ultrahigh temperature RMA requires specialized facilities that are costly and difficult to scale up.

To circumvent these challenges, additive manufacturing (AM) methods have attracted interest due to the capability to fabricate complex shapes with accurate dimensional control. However, aside from the limited work using pure metal powder precursors the application of AM has relied on the availability of alloy powders. While there is some commercial availability of powders for common alloys, the compositions of these alloys do not yield optimum results for the specific solidification conditions involved in AM. At the same time the cost to produce alloy powders with new compositions is high and their commercial availability is low.

### SUMMARY

Methods for forming metal alloys, including refractory intermetallic alloys, and ceramic composites using reactive synthesis during additive manufacturing (AM) are provided.

One embodiment of a method for the synthesis of an intermetallic alloy or a ceramic composite by additive manufacturing includes the steps of: (a) depositing a powder mixture on a substrate or passing a powder mixture through a nozzle, the powder mixture comprising: (i) at least one powder comprising a nitride compound; and (ii) at least one additional powder comprising one or more additional elements of the intermetallic alloy or ceramic composite; and directing a beam of energy onto the powder mixture to melt the powders, wherein the nitride compounds and additional elements react in the melt to form the intermetallic alloy or ceramic composite, and further wherein the reaction releases heat that promotes powder melting and further reaction.

One embodiment of a method for the synthesis of an intermetallic alloy or ceramic composite by additive manufacturing includes the steps of: (a) depositing a powder mixture on a substrate or passing a powder mixture through a nozzle, the powder mixture comprising: (i) at least one powder comprising a silicon carbide compound; and (ii) at least one additional powder comprising one or more additional elements of the intermetallic alloy or ceramic composite; and (b) directing a beam of energy onto the powder mixture to melt the powders, wherein the silicon carbide compound and additional elements react in the melt to form the intermetallic alloy or ceramic composite, and further wherein the reaction releases heat that promotes powder melting and further reaction.

One embodiment of a method of forming a Mo—Si—B alloy that comprises a Moss phase and an intermetallic Mo₅SiB₂ phase and is substantially free of Mo₅Si₃, MoSi₃, and MoO₃ phases includes the steps of: (a) depositing a powder mixture on a substrate or passing a powder mixture through a nozzle, the powder mixture comprising: Mo powder, Si₃N₄ powder and BN powder; or Mo powder, Si powder, and B powder; and (b) directing a beam of energy onto the powder mixture to melt the powders, wherein the Mo powder, Si₃N₄ powder and BN powder or the Mo powder, Si powder, and B powder react in the melt to form the Mo—Si—B alloy, and further wherein the reaction releases heat that promotes powder melting and further reaction.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1 shows the production of bulk alloy samples with different compositions using directed energy deposition (DED).

FIG. 2A shows an illustration of the laser powder bed fusion (LPBF) process.

FIG. 2B is a schematic diagram of an LPBF system.

FIG. 3A is a schematic diagram of a turbine blade having a metal alloy core and an oxidation-resistant coating that can be made using reactive AM.

FIG. 3B shows a 3D graded section of the turbine blade of FIG. 3A.

FIG. 4A. Cr—Si—B phase diagram at 1300° C. (The phase diagrams of FIGS. 4A, 5A, 6A, 7A, and 8A are published by ASM International. See: Matdata.asminternational.org (2023). Available at: https://matdata.asminternational.org/apd/index.aspx).

FIG. 4B. Scanning electron microscope image showing the microstructure of a Cr—Si—B intermetallic alloy.

FIG. 5A. Mo—Ni—B phase diagram at 950° C.

FIG. 5B. Scanning electron microscope image showing the microstructure of a Mo—Ni—B intermetallic alloy.

FIG. 6A. Fe—Si—B phase diagram at 950° C.

FIG. 6B. Scanning electron microscope image showing the microstructure of a Fe—Si—B intermetallic alloy.

FIG. 7A. Mo—Al—Si phase diagram at 1550° C.

FIG. 7B. Scanning electron microscope image showing the microstructure of a Mo—Al—Si intermetallic alloy.

FIG. 8A. Mo—Al—B phase diagram at 1000° C.

FIG. 8B. Scanning electron microscope image showing the microstructure of a Mo—Al—B intermetallic alloy.

FIG. 9. Mo—Si—B alloy objects manufactured via laser powder bed fusion (LPBF).

FIG. 10. Image showing the microstructure of a laser powder bed fusion (LPBF) Mo—Si—B alloy object.

FIG. 11. Compression strain versus stress curve of the object of FIG. 10.

FIG. 12. High magnification image of the Mo—Si—B allow of FIG. 10 showing ultrafine Mo solid solution grains and a secondary T₂ phase in the interdendritic regions.

FIG. 13. Image of Mo—Si—B—Ti alloy cubes manufactured via DED.

FIG. 14. Low magnification image showing the microstructure of a DED-printed Mo—Si—B—Ti alloy and an EDS line scan.

FIGS. 15A and 15B. High magnification images showing the microstructure of a DED-printed Mo—Si—B—Ti alloy with a 10 kgf Vickers' hardness indentation. FIG. 15A shows the microstructure of the indentation. FIG. 15B shows the deformation bands that formed near the indentation.

### DETAILED DESCRIPTION

Methods for forming metal alloys, including refractory intermetallic alloys, and ceramic composites using reactive synthesis during additive manufacturing (AM) are provided. In the AM processes, an exothermic reaction path is used, such that the heat from the reaction drives the synthesis reaction. Using this approach, component powders that are readily available from commercial vendors or easily synthesized using conventional methods are mixed in selected amounts and subsequently reacted via AM to produce metal alloys or ceramic composites. The methods offer a rapid and effective strategy for making metal alloys and/or ceramic composites that have not previously been made using AM processes with tight dimensional control and built-in architectural features.

The use of exothermic reactions in the reactive AM process is highly beneficial because the compound components that react during the deposition can be selected to have relatively similar melting points, which allows for fine composition control. In contrast, when alloys are made by conventional melt casting, the melt is heated to melting temperature of the highest-melting element and, at such high temperatures, elements with lower melting and boiling points can vaporize out of the composition, making it difficult to control the final alloy composition. In addition, the use of the heat generated by the exothermic reaction to drive that reaction can reduce the laser power needed to form the alloys and ceramics. As a result, objects formed by exothermic reactive AM can have reduced residual stress, fewer processing defects, and improved mechanical integrity.

Using the methods described herein, refractory metal alloys and ceramic composites for high-temperature, high-performance components can be produced for aerospace, power generation, and military power conversion applications. Embodiments of the high-temperature reactive AM-fabricated metal alloys and ceramic composites can withstand extreme operating temperatures and are further characterized by high tensile yield and creep strengths and manufacturability. By way of illustration, metal alloys and ceramic composites that can withstand operating temperatures of 1300° C. or higher, have 0.2% tensile yield strengths at 1300° C. of at least 450 MPa, and/or creep strengths (2%; 100 hr) at 130° C. of at least 200 MPa can be fabricated. This includes metal alloys and ceramic composites that can withstand operating temperatures of 1300° C., have 0.2% tensile yield strengths at 1300° C. of at least 400 MPa, and/or creep strengths (2%; 100 hr) at 1300° C. of at least 200 MPa. Moreover, Reactive AM can quickly and inexpensively produce components composed of metal alloys or ceramic composites having bulk densities because layers of precursor powder mixtures can be melted to full, or nearly-full (e.g., >98%), density.

The reactive AM methods use localized, directed energy to form metal alloy or ceramic composite components from powder precursors in a layer-by-layer fabrication without the requirement for molds or dies. During AM the powders are melted using localized energy deposition and the precursors react in the melt to form a metal alloy or ceramic composite. AM synthesis takes place at a sub-millimeter scale to improve the mixing and homogenization of the final composition.

While single-phase alloys and composites can be fabricated, the AM process is particularly well-suited for the production of multiphase metal alloys and ceramic composites. The multiphase alloys and composites reside in thermodynamically stable phase regions and the relative fractions of the coexisting phases in the multiphase materials can be readily controlled. Both the composition of the alloys and composites and the relative phase fractions can be tailored by the choice of precursor powders, initial heating rate, precursor powder packing, and/or atmospheric control during synthesis.

AM processing allows for rapid prototyping and manufacturing of parts that allow three-dimensional (3D) digital models (e.g., computer aided design (CAD) designs) to be converted into three dimensional components by depositing multiple thin layers of material according to a series of two-dimensional (2D), cross-sectional deposition maps sliced from the 3D digital mode. In a typical AM process, a 3D design of a desired geometry (for example, a turbine blade) is created. Typically, this is done using CAD software, which is stored in a file that may be provided to an AM system is a readable format. Directed by the software, the AM system can then fabricate a component of having the desired geometry.

Directed energy deposition (DED) and laser powder bed fusion (LPBF) are two primary AM methodologies. DED uses powder precursors and a laser as a directed energy source. The powder is deposited onto a substrate via a nozzle and then melted using a laser mounted coaxially with the nozzle as the nozzle moves along a predetermined path over the substrate. When the powder particles enter the path of the laser, which may be aided by the use of an inert gas stream, they melt and drop onto the substrate or a previously formed layer of material. DED is a high-throughput method that uses coarse powder precursors—typically with powder sizes of about 40 μm to 150 μm. However, particle sizes outside of these ranges can be used.

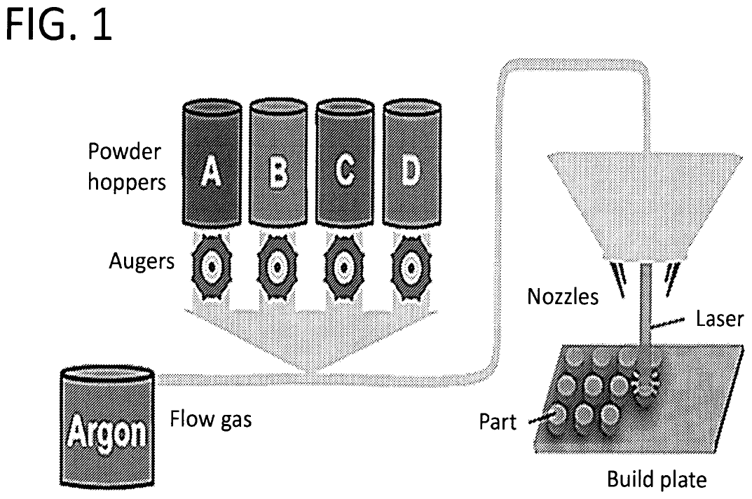

One illustrative DED system is shown the schematic diagram of FIG. 1. The system includes a closed chamber filled with in inert gas (e.g., argon) that is fed by two or more (e.g., four) independently controlled powder hoppers (hoppers A-D). Powders from each hopper are drawn into a gas line of flow gas (e.g., argon) by the rotation of an auger located at the base of each hopper. Each powder hopper contains a powder and can be programmed to produce varying flow rates to produce a different compositional grading in a sample. The powders are aggregated in a central gas line and consequently mixed by the turbulent gas flow during transit to the printhead. At the printhead, the mixed powder is sprayed out by a plurality (e.g., four) of nozzles, typically with rotational symmetry about the optic axis of the printhead, where it encounters a laser impinging on the surface of the substrate. The laser forms a melt pool on the surface of the substrate where incoming powder heated by the laser becomes incorporated. By steering the path of the laser across the surface of the substrate through stage movements, components of a desired 3D geometry can be formed on the substrate. Optionally, the powder deposition may be followed by a laser re-glazing to ensure a complete alloying reaction and the attainment of a desired density. A LENS MR7 is an example of a DED system that can be used. Samples can be produced with 100% melted particles and densities greater than 98%, and typically greater than 99%.

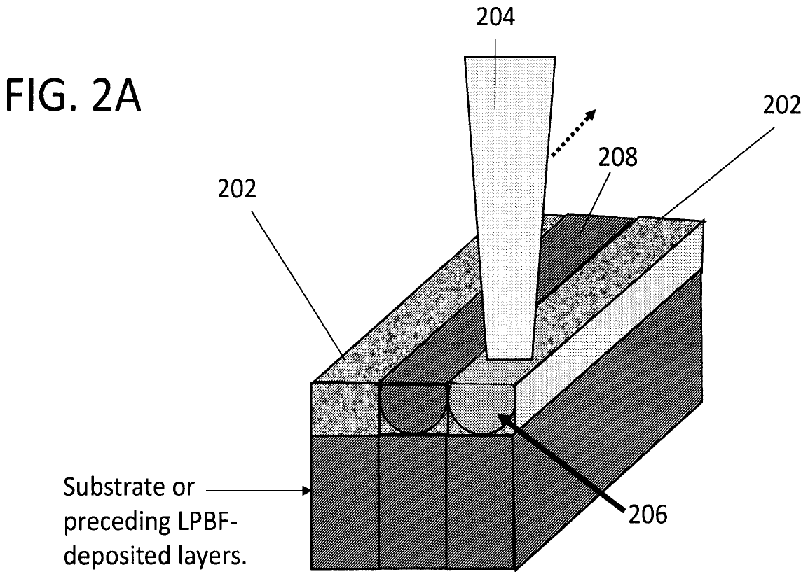

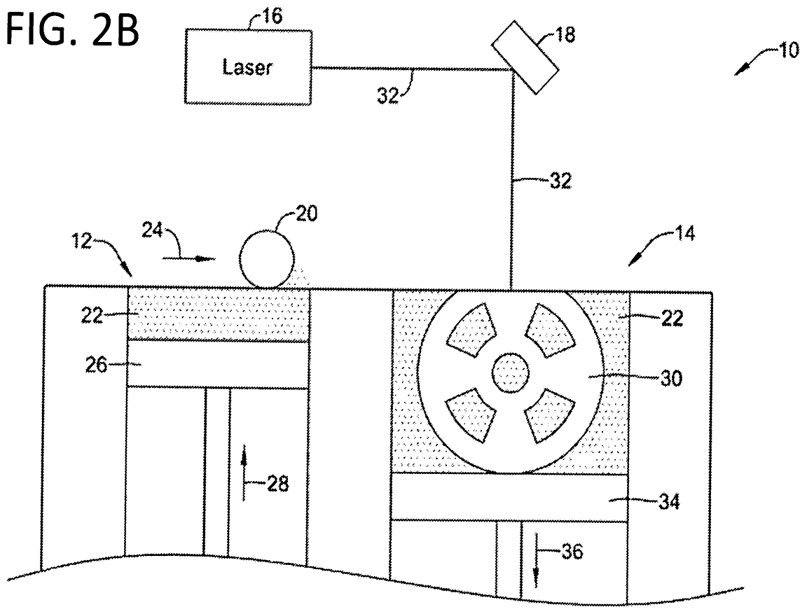

LPBF is another AM technique. FIG. 2A illustrates the LPBF process. In LPBF powder precursors in a powder bed 202 are melted by selectively exposing portions of a powder bed to a focused laser beam 204 which is moved (dotted arrow) relative to the powder bed. (Here, laser beam 204 is on its second pass over the powder bed.) The energy from the laser melts the powders to form a melt pool 206 as it is scanned across the powder bed. The precursors react in the melt pool under an inert cover gas (e.g., argon) and the melt solidifies to form a solid alloy or ceramic 208. LPBF generally uses finer powders than DED. For example, powder sizes in the range of 10 μm to 45 μm may be used. However, powder sizes outside of this range can also be used. The LPBF process permits complex 3D geometries through the use of scaffolding and has fine dimensional tolerance.

Layer-by-layer fabrication via LPBF has the ability to scale-up components and offers a range of structural and dimensional control. LPBF also enables control of microstructure through the key operational parameters of laser power (P), laser speed (v), hatch spacing (h), and layer thickness (t). Using the LPBF method, large size samples can be produced with a variety of dimensionally controlled geometric shapes according to a pattern determined from a CAD file. The use of LPBF is advantageous because it has the ability to produce full, or near full, density functional components.

FIG. 2B shows additional details of one illustrative LPBF system 10 configured to fabricate 3D components based on a 3D design geometry in a CAD file. More details are provided in U.S. patent application publication number 2021/0260829. The LPBF system 10 may include, among other features, a powder delivery bed 12, a fabrication powder bed 14, a laser 16, a scanner system 18, and a roller 20 or other suitable powder moving component. The powder delivery bed 12 may be configured to deliver a powder mixture 22 to the roller 20 for transportation to the fabrication powder bed 14 in response to movement of the roller 20 in the direction of arrow 24. The powder delivery bed 12 may include a powder delivery piston 26 configured to move in the direction of arrow 28 to advance the powder mixture 22 to the roller 20. The powder delivery piston 26 may be configured to advance in a direction of arrow 28 at one or more predetermined continuous or non-continuous rates. In some cases, the powder delivery piston 26 may be biased to move in the direction of arrow 28 by a biasing element (e.g., a spring, etc.), where a weight of the powder 22 may counter balance the biasing element. Alternatively, or in addition, the powder delivery piston 26 may be in communication with a controller of the LPBF system 10 and configured to advance in the direction of the arrow 28 in response to a control signal from the controller specifying an advancement distance and/or rate configured to facilitate forming a layer of powder mixture 22 of a predetermined thickness on the fabrication powder bed 14. Further, the roller 20 may be in communication with the controller of the LPBF system 10 to facilitate forming layers of powder 22 with the predetermined thickness.

The fabrication powder bed 14 may be configured to receive powder mixture 22 that is configured to be melted into a component 30. Once a layer is formed on the fabrication powder bed 14, a laser beam 32 from the laser 16 may be directed by the scanner system 18 to one or more locations on the layer to melt the powder mixture 22 at the one or more locations and form a layer of the component 30. The scanner system 18 may include and/or may be in communication with a controller of the LPBF system 10 and may be configured to direct the laser beam 32 to locations on the layer of powder 22 based on a layer of the 3D geometry in the CAD file being used to create the component 30. The laser beam 32 may be configured to melt particles of powder mixture 22 forming the layer on the fabrication powder bed 14 to other particles of powder mixture 22 in the layer and/or to particles of one or more previous layers of powder 22 on the fabrication powder bed 14 to form the component 30. In some cases, the scanner system 18 may include a motor and/or a mirror. When included, the motor may be configured to move and/or adjust the mirror to facilitate directing the laser beam 32 to one or more locations of the layer of powder on the fabrication powder bed 14.

The fabrication powder bed 14 may include a fabrication piston 34 configured to move in a direction of arrow 36 to facilitate receiving additional layers of powder mixture 22 in response to movement of the roller 20 in the direction of arrow 24. The fabrication piston 34 may be configured to advance in the direction of arrow 36 at one or more predetermined continuous or non-continuous rates. In some cases, the fabrication piston 34 may be biased to move in a direction opposite of arrow 36 by a biasing element (e.g., a spring, etc.), where a weight of the powder mixture 22 and the component 30 at the fabrication powder bed 14 may counter balance the biasing element. Alternatively, or additionally, the fabrication piston 34 may be in communication with a controller of the LPBF system 10 and configured to advance in the direction of the arrow 36 in response to a control signal from the controller specifying an advancement distance and/or rate configured to facilitate forming a layer of powder mixture 22 of a predetermined thickness on the fabrication powder bed 14 and a resulting layer of the component 30.

The AM-based fabrication methods can be used to form a wide variety of metal alloys and ceramic composites that have not previously been formed via AM, including some alloys have melting points that are too high to be fabricated into components using more conventional methods. Illustrative examples of metal alloys that can be fabricated include, but are not limited to, transition metal silicides, transition metal borides, transition metal nitrides, refractory metal silicides, refractory metal borides, and refractory metal nitrides, where the transition metals are those elements in Groups 3 through 5 of the periodic table.

Refractory metal alloys (RMAs) are examples of high-value metal alloys that can be made using the methods described herein. The RMAs are metal alloys that include one or more of the refractory metal elements having the common property of a very high melting point (e.g., ≥2000° C.). The refractory metal elements are a sub-set of the transition metals. Elements widely recognized as belonging to the class of refractory metals include molybdenum (Mo), chromium (Cr), tungsten (W), niobium (Nb), tantalum (Ta), and rhenium (Re). For the purposes of this disclosure, refractory metals also cover a wider class of metal elements which includes: vanadium (V), hafnium (Hf), titanium (Ti), zirconium (Zr), ruthenium (Ru), osmium (Os), rhodium (Rh), and Iridium (Ir). In the refractory metal alloys, the one or more refractory metals may be alloyed with one or more non-refractory metal elements and/or metalloid elements or non-metal elements, such as silicon (Si), carbon (C), Aluminum (Al) and/or boron (B).

The metal alloys and ceramics fabricated via AM may be single-phase alloys or ceramics, or may include two, three, or more alloy phases. For example, the metal alloys may be intermetallic alloys in which intermetallic compound phases are dispersed in a metal matrix. In the intermetallic alloys, the metal matrix provides the alloy with ductility and the intermetallic phases are selected to provide desired alloy strength and performance characteristics.

Each of the one or more phases present within the metal alloy or ceramic may be a single element (i.e., a pure metal phase), a binary alloy or ceramic phase (i.e., a phase composed of two elements, a ternary alloy or ceramic phase (i.e., a phase composed of three elements), or a higher order phase. Multiple phases can be produced by including one or more of the precursor powders in excess.

The particular powders used to form an alloy will be selected based on the desired alloy composition. Multiphase alloys and ceramic composites having dense and thermodynamically stable phase regions that provide desired mechanical and oxidation resistance properties can be identified by thermodynamic and kinetic modeling using CALculation of PHAse Diagrams (CALPHAD) to obtain multi-component phase diagrams. CALPHAD modeling can also be used to identify appropriate solidification pathways for obtaining a desired alloy composition.

The selection of alloys having the desired phases and the identification of appropriate solidification pathway can be further refined, and the AM processing parameters can be optimized, by using a rapid AM fabrication technique for the rapid production of samples for microstructure testing and the validation of the results of the CALPHAD modeling. DED is a cost-effective, high-throughput AM process that can be used to prepare samples of metal alloys or ceramic composites for testing.

While DED is suitable for making components composed of metal alloys and ceramic composites on a small scale as well as repair or recontouring applications, LPBF is better suited for scaled-up component fabrication. Initial results from samples made using DED, including suitable AM processing parameters, can be used to guide the initial selection of processing parameters for LPBF fabrication. If necessary or desirable, the LPBF processing parameters may then be further optimized based on microstructure, defect, and residual stress testing of the alloy or composite samples made via LPBF.

Guidance for the selection of processing parameters for LPBF can also be provided using a dimensionless number that has been developed to evaluate processing parameters as a function of thermophysical properties to define processing bounds within LPBF. (Rankouhi, Behzad, et al, “A dimensionless number for predicting universal processing parameter boundaries in metal powder bed additive manufacturing.” Manufacturing Letters 27 (2021): 13-17.) This dimensionless number correlates processing parameters with a component's density, allowing for an initial prediction of suitable processing parameters. The dimensionless number (Π=CₚEᵢₙτ/k) ((Eᵢₙ=P/v·h·t), where Eᵢₙ is volumetric energy density, P is laser power, v is laser scan speed, h is hatch spacing, and t is layer thickness; Cₚ is specific heat, k is thermal conductivity, and τ is the laser beam diameter/laser scan speed) bounds the processing energy density. Based on these initial predictions, commercially available random forest regression methods can be used to predict the outputs from large potential input parameters sets (e.g., the over 100 process parameter settings in LPBF).

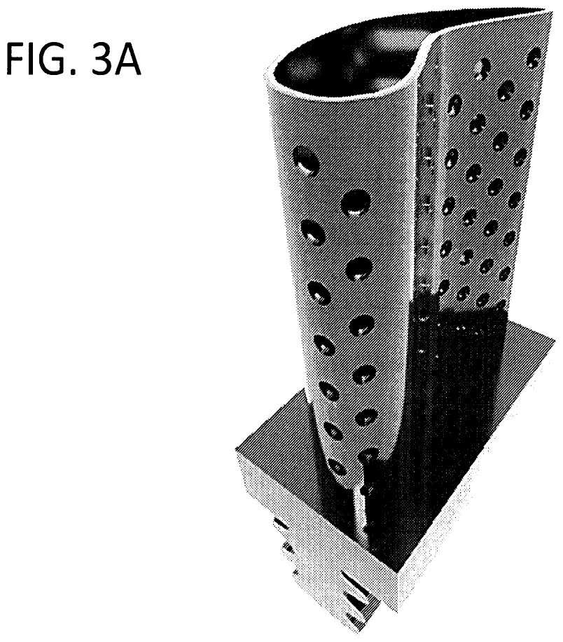

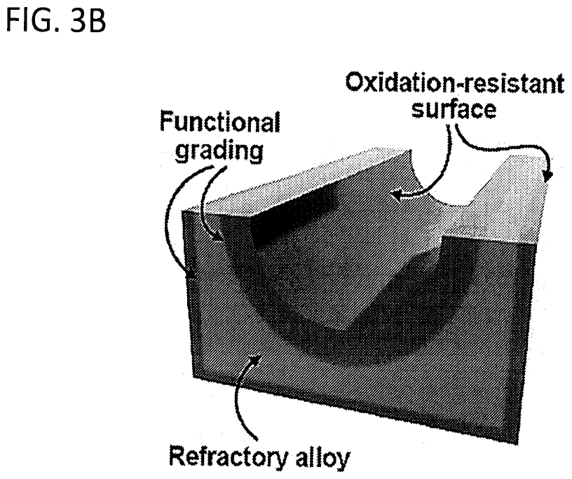

Thermodynamic and kinetic modeling and processing parameter optimization can also be used to make 3D hybrid components with multi-metal functional grading. For example, a component, such as a turbine blade can be made via reactive AM with a refractory metal alloy core, an oxidation-resistant surface, and a functionally graded material layer separating the core from the coating (FIG. 3A and 3B).

The particular reactive powders used to fabricate a desired alloy composition can be chosen based on the exothermic reaction pathway designed drive the AM reaction. Depending upon the reaction path, the powders may be composed of pure elements (elemental powders), compounds (compound powders), or a mixture thereof. The pure elements may be refractory metal elements (e.g., Mo, W, Ti), non-refractory metal elements (Fe), metalloid elements (e.g., Si, B), or non-metal elements (e.g., C). The compounds may be metal compounds, wherein the metal may be a refractory metal or a non-refractory metal, or compounds of metalloids and/or non-metals. Additionally, powders of elements that dissolve in a phase of the metal alloy or ceramic composite can be included in the powder mixture in order to tailor the properties of the alloy or composite.

Powders of nitride compounds are examples of reactants that can be used in exothermic AM reactions to drive the formation of a variety of high-value metal alloys and ceramic composites. In these reactions the nitride from the reactant particles may be released as nitrogen (N_{2(g)}) or incorporated into an alloy or composite phase of the fabricated metal alloy or ceramic composite. Silicon nitride (Si₃N₄), boron nitride (BN), and aluminum nitride are examples of nitride compounds that can be used to form a variety of stable alloys or composites when reacted with metals, metalloids, and non-metals, in elemental or compound form, using directed energy deposition. Non-limiting, illustrative examples of reactions that generate heat to promote reactive AM are provided below.

### Mo—Si—B Alloys

Mo—Si—B alloys are high-temperature structural alloys that have received much attention due to their high melting points and oxidation resistance. Mo—Si—B alloys include a high-melting ternary Mo₅SiB₂ phase, which is referred to as the T2 phase. The Mo—Si—B are conventionally produced as three-phase alloys in which a Moₛₛ and Mo₃Si phase are also present. Alternatively, the T2 phase made be formed with Moₛₛ and Mo₅Si₃ (T1) phases. The alloying reaction can be controlled to form two-phase Mo—Si—B alloys and/or Mo—Si—B alloys comprising additional phases, such as Mo₂B.

Examples of Mo—Si—B alloys that can be made via AM include two-phase alloys of Moₛₛ and T2. Such alloys can be formed free of T1, MoSi₃, and/or MoO₃ phases.

The AM fabrication of the T2 alloy phase can be carried out using elemental Mo powder, silicon nitride powder, and boron nitride powder in the following reaction:

5Mo+⅓Si₃N₄+2BN→Mo₅SiB₂+5/3N₂.

This reaction can be triggered above about 1000° C. with modest liberated N₂ pressures (about 10⁻³ atm at about 1700° C.). For the fabrication of a two-phase Moₛₛ+T2 refractory metal alloy, an excess of Mo powder is included in the reaction to generate a Mo matrix. Additionally, other components can be added that are soluble in the Moₛₛ and/or T₂ phases or that generate other phases.

The fabrication of a two-phase Moₛₛ+T2 refractory metal alloy rather than the three-phase Moₛₛ+Mo₃Si+T2 alloy is advantageous because this two-phase alloy can be produced with a reduced Si content in the Moₛₛ, which improves ductility and fracture resistance, while retaining high oxidation resistance, yield strength, and thermal conductivity.

Alternatively, Mo—Si—B alloy synthesis can be achieved from the reaction of elemental powders due to the enthalpy of mixing in the liquid phase, but in this case without any N₂ product, according to the following reaction:

5Mo+Si+2B→Mo₅SiB₂.

An excess of Mo powder can be included in the reaction for the fabrication of the two-phase Moₛₛ+T₂ intermetallic refractory metal alloy.

Optionally, the powder mixtures used to fabricate the Mo—Si—B alloys can include powders of elements that dissolve in a phase of the alloys. For example, in order to produce an Mo—Si—B alloy with a density of less than 9 g/cm³, Ti powder (ρ=4.5 g/cm³) can be included in the powder mixture. Ti has a high solubility in the Moₛₛ (ρ=10.23 g/cm³) and can substitute for the Mo in the T₂ phase (ρ=8.73 g/cm³) at levels up to more than 20 at % before there is a change in the phase stability. With a substitution level of about 10 at % Ti in an alloy with phase fractions of about 30% Moₛₛ and about 70% T₂, the density is about 8.5 g/cm³. This demonstrates that the phase stability should remain unaltered by a 10 at % Ti substitution level.

### Transition Metal/Refractory Metal Silicides

Transition metal and refractory metal silicides are also of interest for structural materials due to their high temperature strength and creep properties and high melting points. A variety of transition metal and refractory metal alloys can be made via reactive AM. By way of illustration, Fe₃Al₂Si₃ can be fabricated from elemental Fe powder, AN powder, and silicon nitride powder in the following reaction:

7Fe+2AlN+2Si₃N₄→5N_{2(g)}+Fe₃Al₂Si₃+3FeSi+Fe.

Here, the Fe solid solution (Feₛₛ) is strengthened by the intermetallic phases, which also provide an oxidation resistant coating upon high temperature exposure.

An example of reactive AM-based refractory metal silicide fabrication is the fabrication of three-phase niobium- and tungsten silicide alloy from W powder, niobium nitride powder, and silicon nitride powder according to the following exothermic reaction:

15W+18NbN+8Si₃N₄→25N₂+3W₅Si₃+3Nb₅Si₃+3NbSi₂.

By including excess niobium in the reactive powders, an intermetallic alloy in which the silicide phases are dispersed in a niobium metal matrix can be produced.

Yet another example of reactive AM-based refractory metal silicide fabrication is the fabrication of three-phase Mo—Al—Si alloy from molybdenum powder, aluminum nitride powder, and silicon nitride powder according to the following exothermic reaction:

Mo+AlN+Si₃N₄→N₂+Mo₃(Al,Si)+Mo₅Si₃+MoAl,

Where the Mo₃(Al,Si) forms a continuous matrix and the Mo₅Si₃ and MoAl phases are dispersed therein.

### Transition Metal/Refractory Metal Borides

Metal boride alloys are another example of high-temperature alloys that can be fabricated with high hardness and fracture toughness. Such alloys include single and multi-phase alloys that include transition and refractory metal diboride phases. An illustrative example of a multi-phase metal boride alloy comprising a titanium diboride phase can be made from Fe powder, TiN powder, and BN powder according to the following reaction:

6Fe+2TiN+8BN→5N₂+2TiB₂+2FeB+2Fe₂B.

Here, excess iron can be included in the reactive powders to form an intermetallic alloy in which the boride phases are dispersed in a titanium metal matrix.

Another example of a multi-phase metal boride alloy comprising a molybdenum boride phase can be made from Mo powder, Ni₃N powder, and BN powder according to the following reaction:

24Mo+7Ni₃N+BN→4N₂+Moₛₛ+3Mo₇Ni₇+Mo₂B.

Here, excess Mo can be included in the reactive powders to form an intermetallic alloy strengthened by the intermetallic phases.

Yet another example of a multi-phase metal boride alloy comprising a molybdenum boride phase can be made from Mo powder, AlN powder, and BN powder according to the following reaction:

6Mo+AlN+BN→N₂+Moₛₛ+Mo₃Al+Mo₂B.

Here, excess Mo can be included in the reactive powders to form an intermetallic alloy strengthened by the intermetallic phases.

### Transition Metal/Refractory Metal Silicon Carbides

Transition and refractory metal silicon carbide metal alloys having high melting points, high strength, high thermal conductivities, and high oxidation resistance are other examples of high-temperature structural materials that can be fabricated via reactive AM aided by heat release during the reaction. By way of illustration, a two-phase alloy comprising titanium silicon carbide (Ti₃SiC₂) can be fabricated from SiC powder, Ti powder, and C powder according to the following reaction:

2SiC+3Ti+C→Ti₃SiC₂+SiC.

Alternatively, a three-phase alloy can be fabricated from the same powders according to the reaction:

2SiC+4Ti+2C→Ti₃SiC₂+SiC+TiC.

In either case, an intermetallic alloy in which the carbide phases are dispersed in a titanium matrix can be formed by using excess titanium in the reactive powders.

### Transition Metal/Refractory Metal Silicides and Borides

Intermetallic alloys that include both a metal silicide phase and a metal boride phase can also be formed via an exothermic reaction. By way of illustration, an alloy comprising a chromium silicide and a chromium boride can be fabricated from elemental Cr powder, BN powder, and silicon nitride powder in the following reaction:

28Cr+2BN+2Si₃N₄→5N_{2(g)}+2Crₛₛ+2Cr₄B+6Cr₃Si.

Here, excess Cr in the reactive powder produces a Cr solid solution (Crₛₛ) in which the silicide and boride phases are dispersed.

Another example is an alloy comprising an iron silicide and an iron boride that can be fabricated from elemental Fe powder, BN powder, and silicon nitride powder in the following reaction:

21.4Fe+BN+Si₃N₄→0.5N_{2(g)}+Feₛₛ+Fe₂B+10.7Fe_{1.72}Si_{0.28}.

Here, excess Fe in the reactive powder produces an Fe solid solution (Feₛₛ) in which the silicide and boride phases are dispersed.

### Silicon Carbide-Boron Nitride Composites

Silicon carbide (SiC) is a ceramic that is used for structural components in high-temperature applications. SiC can be combined with other material phases in order to improve its mechanical or corrosion resistance properties. For example, the presence of BN in a SiC-BN composite improves shock and corrosion resistance. Using the AM methods described herein, a SiC-BN composite can be fabricated from Si₃N₄ powder, B powder, and C powder according to the following reaction:

Si₃N₄+4B+3 C→3SiC+4BN.

### EXAMPLES

The following examples are presented as evidence of the ability of intermetallic alloys to form microstructures containing a majority metal solid solution matrix phase that provides ductility and dispersed intermetallic phases that provide for strengthening and high temperature creep resistance. The synthesized microstructures have a uniform arrangement of the constituent phases without any evident clustering or aggregation of the phases.

### Example 1: Cr—Si—B

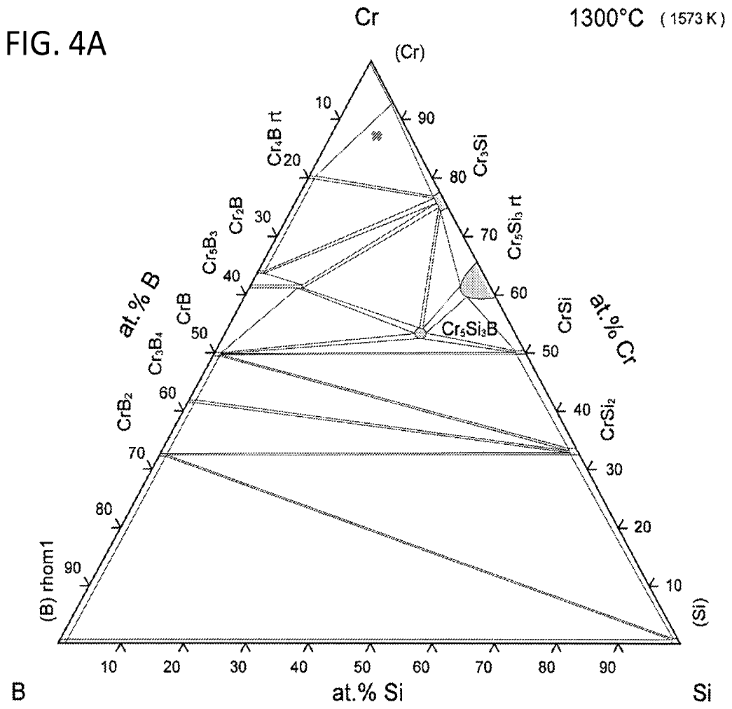

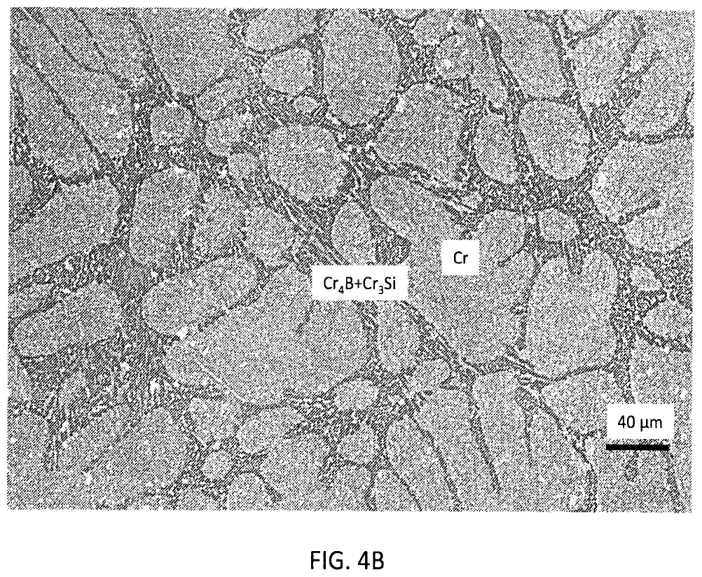

An intermetallic alloy of chromium, silicon, and boron was formed by mixing powders of Cr, BN, and Si₃N₄ in stoichiometric quantities. The powder mixture was packed in an alumina crucible and pressed by hand. The crucible was then placed in a high vacuum furnace (1×10⁻³ Pa) and heated to 1450° C. for a period of 10 minutes. The resulting alloy material had a composition of 85 atomic percent (at. %) Cr, 10 at. % Si, and 5 at. % B. The composition is indicated by a cross in the Cr—Si—B ternary phase diagram (at 1300° C.) of FIG. 4A. The microstructure of the alloy material formed immediately after rapid cooling is shown in FIG. 4B. As shown in FIG. 4B, the alloy microstructure included a majority Cr solid solution matrix and an inter-grain region consisting of Cr₄B and Cr₃Si. This pre-annealing microstructure is controlled by the solidification sequence. After a heat treatment (anneal), the microstructure will be converted into a continuous ductile Cr solid solution matrix phase with dispersed intermetallic phases, as discussed above. (X-ray diffraction analysis and back-scattered scanning electron microscopy imaging were used to identify the phases.)

### Example 2: Mo—Ni—B

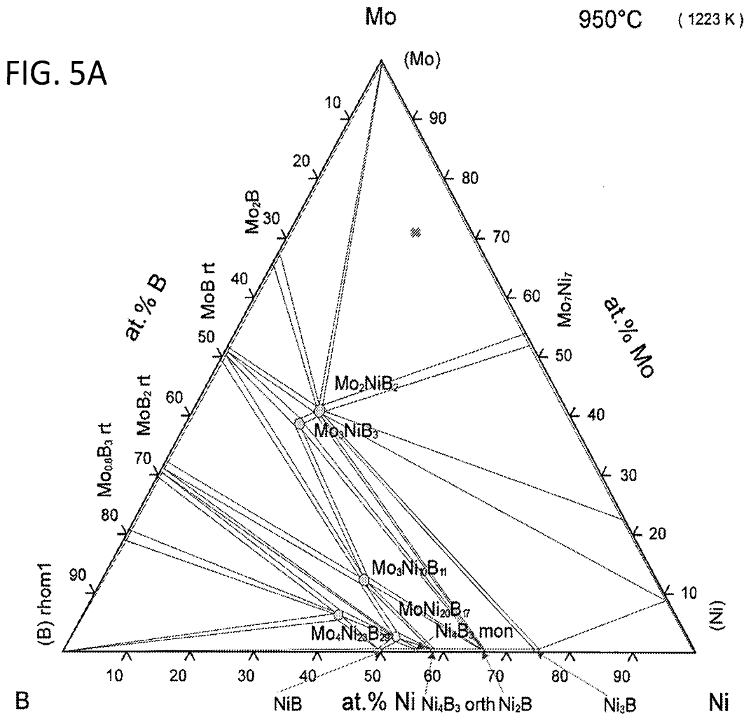

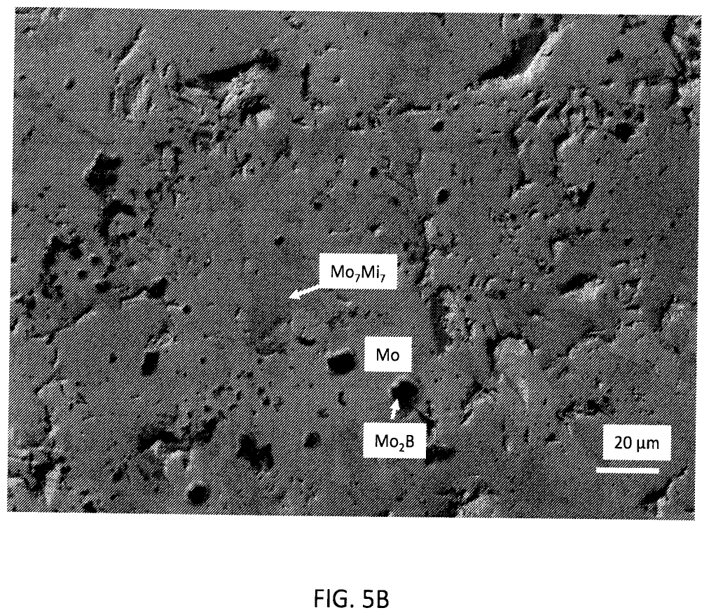

An intermetallic alloy of molybdenum, nickel, and boron was formed by mixing powders of Mo, BN, and Si₃N₄ in stoichiometric quantities. The powder mixture was packed in an alumina crucible and pressed by hand. The crucible was then placed in a high vacuum furnace (1×10⁻³ Pa) and heated to 1600° C. for a period of 10 minutes. The resulting alloy material had a composition of 75 atomic percent (at. %) Mo, 15 at. % Ni, and 10 at. % B. The composition is indicated by a cross in the Mo—Ni—B ternary phase diagram (at 950° C.) of FIG. 5A. The microstructure of the alloy material is shown in FIG. 5B. As shown in FIG. 5B, the alloy microstructure included a majority Mo solid solution matrix (bright phase) and dispersed Mo₂B (black) and Mo₇Ni₇ (grey) phases. (X-ray diffraction analysis and back-scattered scanning electron microscopy imaging were used to identify the phases.)

### Example 3: Fe—Si—B

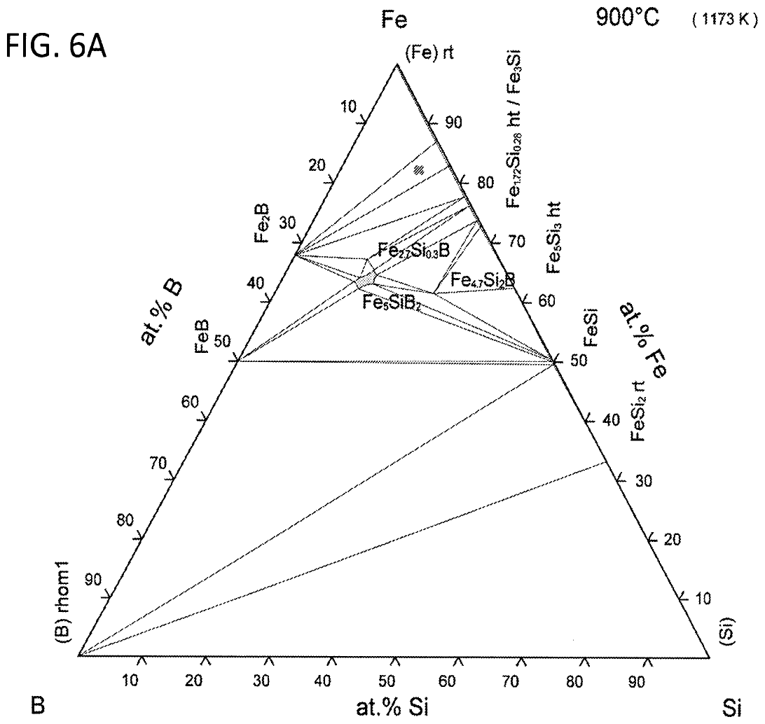

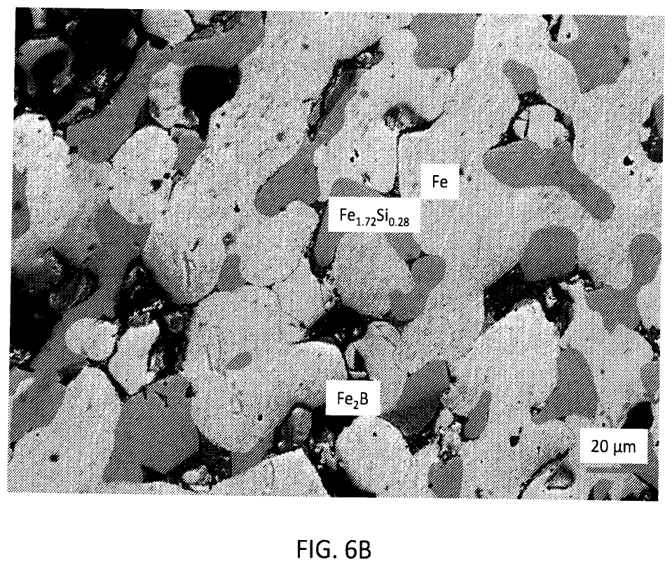

An intermetallic alloy of iron, nickel, and boron was formed by mixing powders of Fe, BN, and Si₃N₄ in stoichiometric quantities. The powder mixture was packed in an alumina crucible and pressed by hand. The crucible was then placed in a high vacuum furnace (1×10⁻³ Pa) and heated to 1300° C. for a period of 10 minutes. The resulting alloy material had a composition of 83 atomic percent (at. %) Fe, 12 at. % Si, and 5 at. % B. The composition is indicated by a cross in the Fe—Ni—B ternary phase diagram (at 900° C.) of FIG. 6A. The microstructure of the alloy material is shown in FIG. 6B. As shown in FIG. 6B, the alloy microstructure included a majority Fe solid solution matrix (bright phase) and dispersed Fe₂B (black) and Fe_{1.72}Si_{0.28} (grey) phases. (X-ray diffraction analysis and back-scattered scanning electron microscopy imaging were used to identify the phases.)

### Example 4: Mo—Al—Si

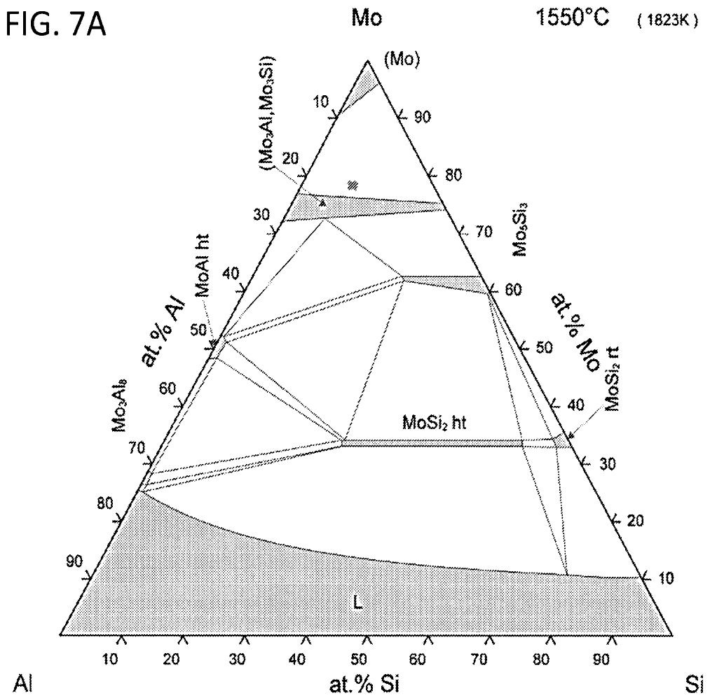

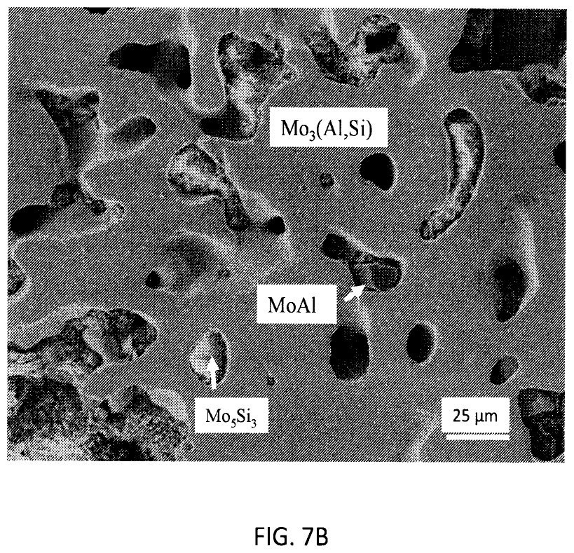

An intermetallic alloy of molybdenum, aluminum, and silicon was formed by mixing powders of Mo, AlN, and Si₃N₄ in stoichiometric quantities. The powder mixture was packed in an alumina crucible and pressed by hand. The crucible was then placed in a high vacuum furnace (1×10⁻³ Pa) and heated to 1900° C. for a period of 12 minutes. The resulting alloy material had a composition of 67 atomic percent (at. %) Mo, 23 at. % Al, and 10 at. % Si. The composition is indicated by a cross in the Mo—Al—Si ternary phase diagram (at 1500° C.) of FIG. 7A. The microstructure of the alloy material is shown in FIG. 7B. As shown in FIG. 7B, the alloy microstructure included a majority (Mo₃(Al,Si)) solid solution matrix and dispersed phases consisting of Mo₅Si₃ and MoAl. (X-ray diffraction analysis and back-scattered scanning electron microscopy imaging were used to identify the phases.)

### Example 5: Mo—Al—B

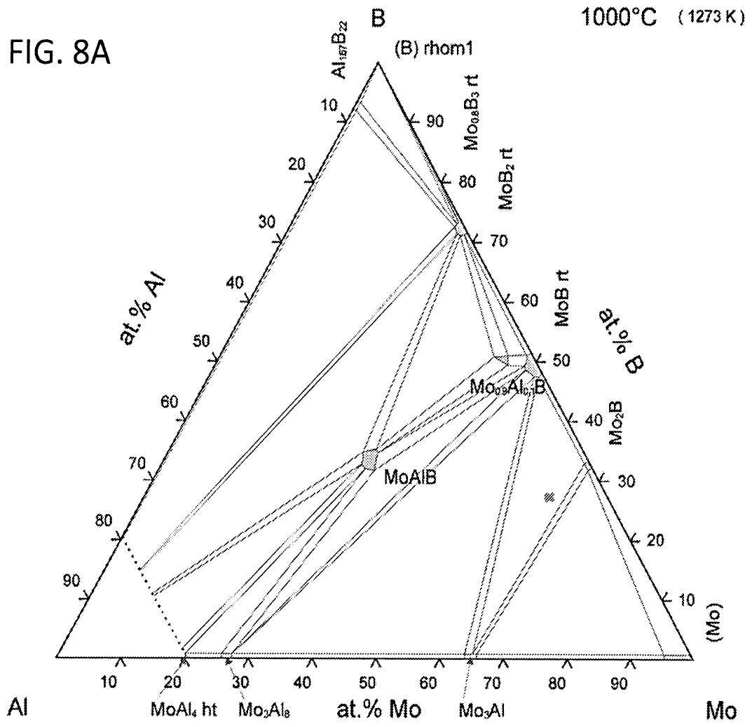

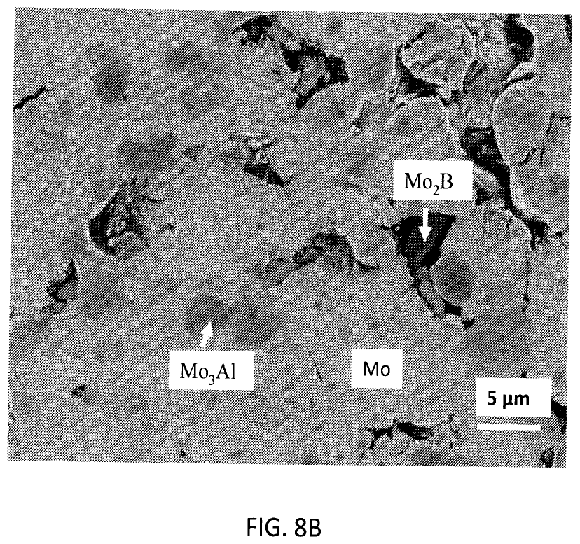

An intermetallic alloy of molybdenum, aluminum, and boron was formed by mixing powders of Mo, AlN, and BN in stoichiometric quantities. The powder mixture was packed in an alumina crucible and pressed by hand. The crucible was then placed in a high vacuum furnace (1×10⁻³ Pa) and heated to 1900° C. for a period of 12 minutes. The resulting alloy material had a composition of 80 atomic percent (at. %) Mo, 10 at. % Al, and 10 at. % B. The composition is indicated by a cross in the Mo—Al—B ternary phase diagram (at 1000° C.) of FIG. 8A. The microstructure of the alloy material is shown in FIG. 8B. As shown in FIG. 8B, the alloy microstructure included a majority Mo solid solution matrix and dispersed phases consisting of Mo₃Al and Mo₃B. (X-ray diffraction analysis and back-scattered scanning electron microscopy imaging were used to identify the phases.)

### Example 6. Additive Manufacturing of Refractory Metal Alloy Using Exothermic Reaction

Three-dimensional objects of an Mo—Si—B—Ti alloy were manufactured using LPBF and DED. The exothermic reaction for the reactive synthesis is as follows:

5Mo+1/3Si₃N₄+2BN→Mo₅SiB₂+5/3N₂. The reaction is exothermic, with a Gibbs free energy (ΔG) at 1000° C., 1 atm, of −271 kJ/mol, and at 2000° C., of −892 kJ/mol. An excess of Mo and addition of Ti is used to synthesize a Mo+T₂ alloy.

The powder mixture was composed of Mo powder (5 μm), Si₃N₄(15 μm), BN (20 μm) and Ti powder(44 μm). The weight percentages were: Mo powder−91.37%; Si₃N₄ powder—1.79%, BN powder—1.29% and Ti powder—5.55%.

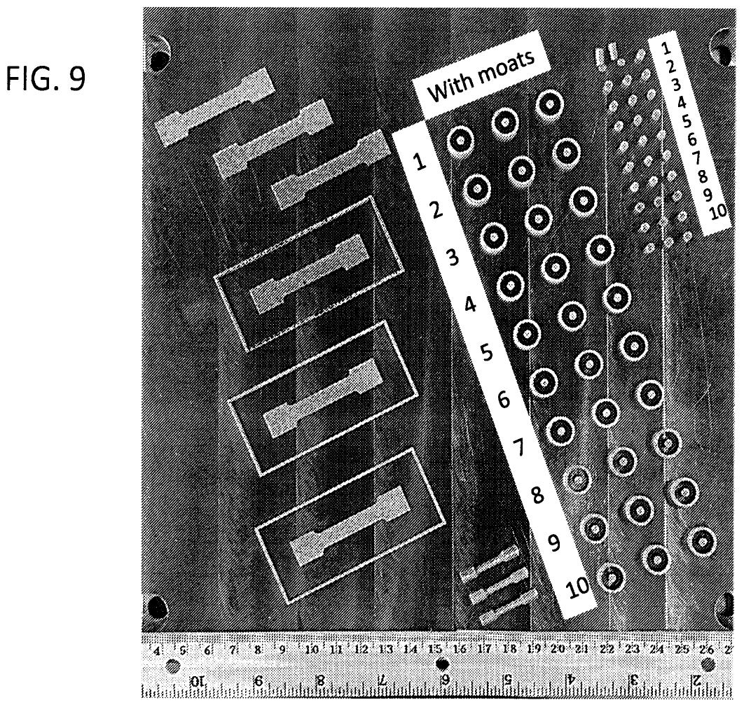

The objects shown in FIG. 9 were manufactured by a LPBF 3D printer (EOS M290; an LPBF instrument). The printing parameters were: laser power (200-320 W); scanning speed (800-1200 mm/s); hatch spacing (0.07-0.09 mm); and layer thickness (0.01-0.04 mm).

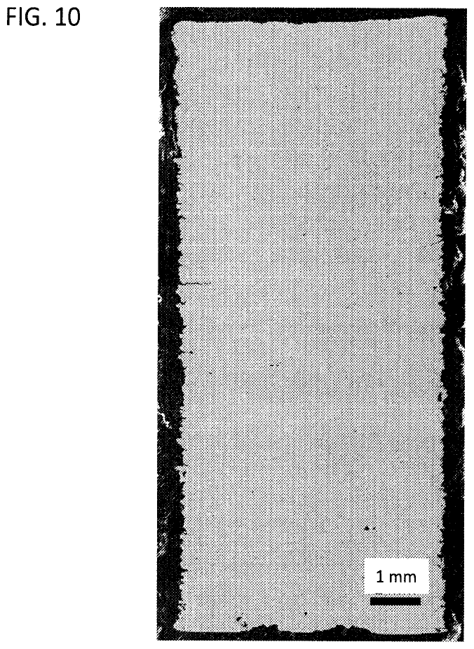

FIG. 10 shows the low magnification microstructure image of an object formed using the following printing parameters: 240 W laser power; 800 mm/s scanning speed; 0.07 mm hatch spacing; and 0.03 mm layer thickness. As seen in the image, the sample had a high density. By including excess Mo in the powder mixture, a molybdenum alloy having a Mo solid state matrix with disperses T2 phase was printed. The small quantity of Ti was added to modify the density of the alloy. Ti is soluble in both the Mo matrix and the T2 phase and, therefore, was present in both phases of the final alloy.

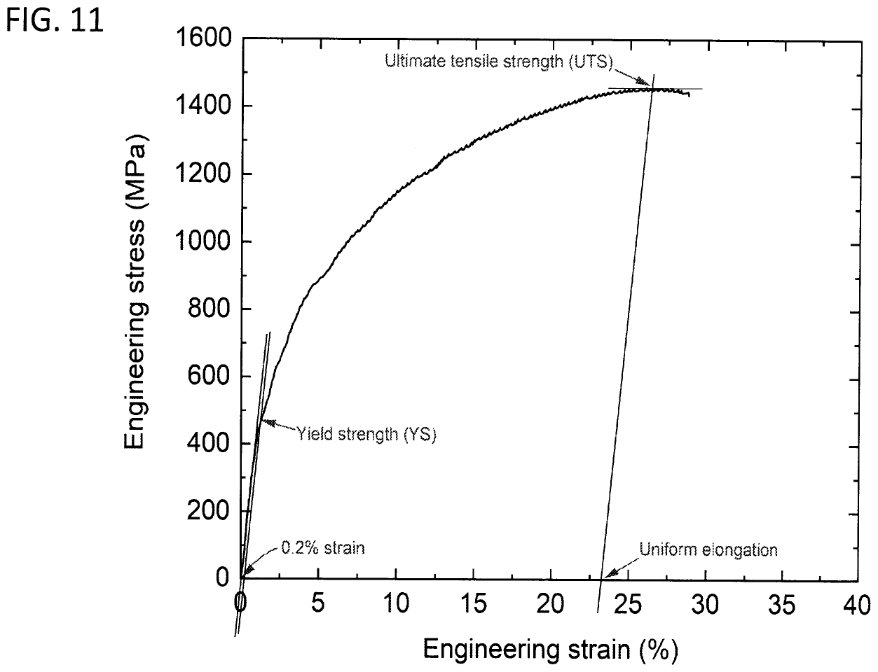

FIG. 11 shows a compression curve of the object in FIG. 10, the compression test was carried out on a MTS Criterion Series 40 testing system. The compression strain rate is 5×10⁻⁴. The results confirm that the sample had high strength and ductility.

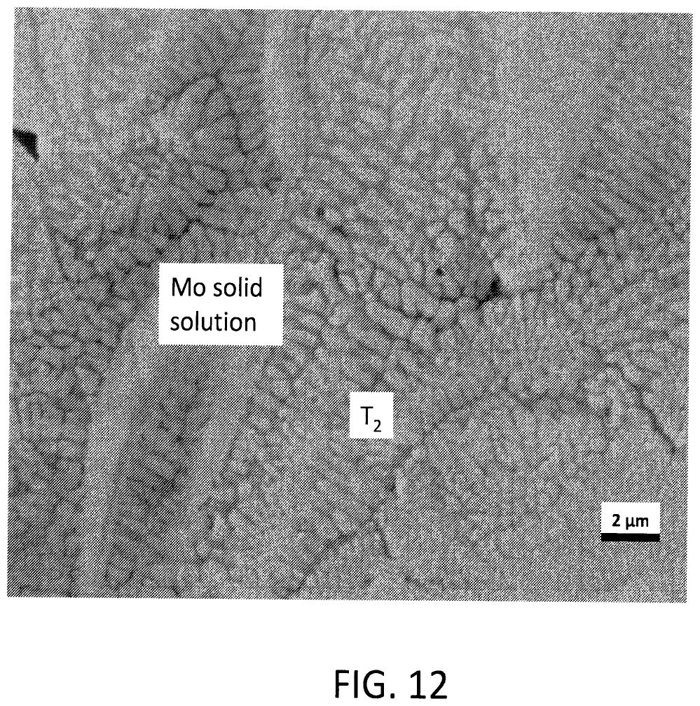

FIG. 12 shows the high magnification microstructure of object in FIG. 10. The image is taken by Zeiss Gemini 450 scanning electron microscopy (SEM). It is a back-scatter electron image and shows ultrafine Mo solid solution grain and secondary T2 phase at the interdendritic region, with a dendritic arm spacing is around 400 nm. The alloy was free of T1, MoSi₃, and/or MoO₃ phases. This pre-annealing microstructure is controlled by the solidification sequence. After a heat treatment (anneal), the microstructure will be converted into a continuous ductile Mo solid solution matrix phase with dispersed intermetallic phases, as discussed above.

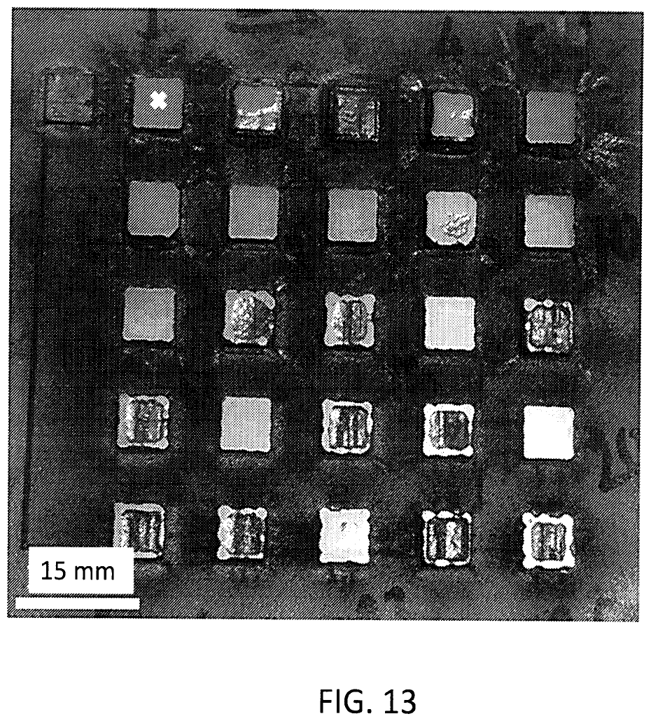

FIG. 13 shows objects (cubes) are manufactured by a direct metal deposition 3D printer (LENS MR7; a DED instrument). The printing parameters were: laser power (700-800 W); feed rate (10-12 inch/min); hatch spacing (0.01 inch); layer thickness (0.01 inch); and mass flow rate (5-7 g/min).

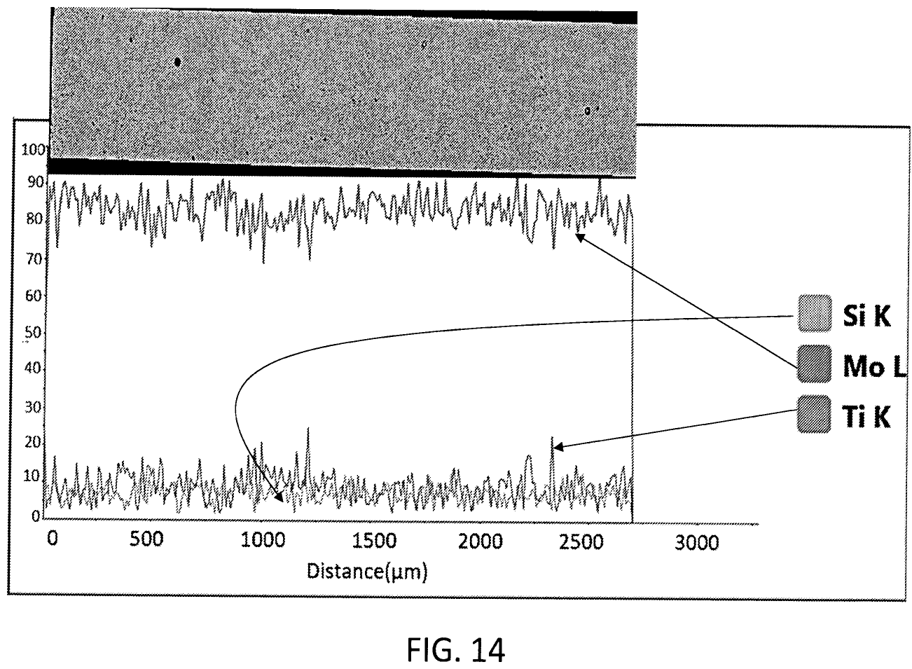

FIG. 14 shows a low magnification microstructure of the direct energy deposition printed Mo—Si—B—Ti cube in the upper left corner of FIG. 13 (marked with a white x) and an EDS line scan. The image was taken by Zeiss Gemini 450 scanning electron microscopy (SEM). It is a back-scatter electron image. The composition line scan was carried out by Energy-dispersive X-ray spectroscopy (EDS). FIG. 14 shows uniform composition over a mm-scale distance, which demonstrates excellent composition control for the AM of the alloys.

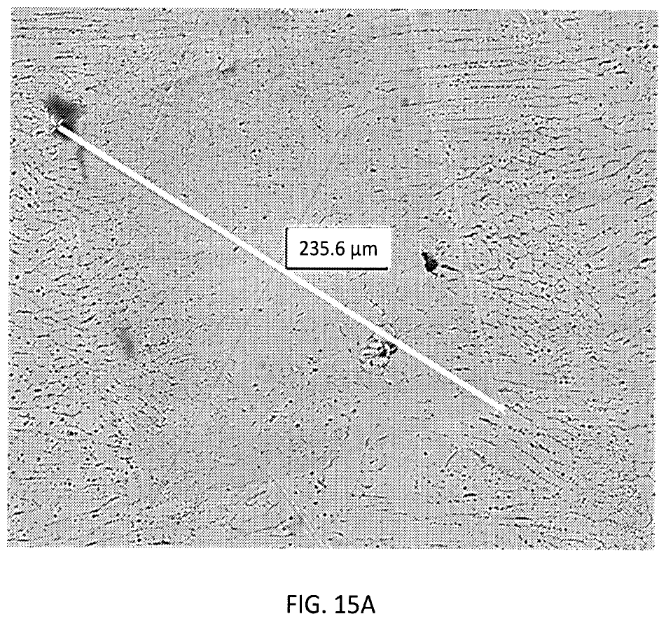

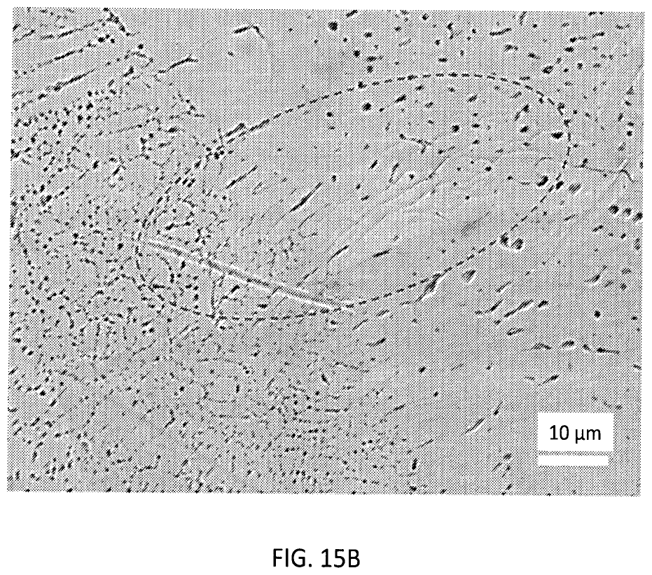

FIGS. 15A and B show the microstructure of the DED-printed Mo—Si—B—Ti cube in the upper left corner of FIG. 13 and its 10 kgf Vickers' hardness indentation. The images were taken on a Zeiss Gemini 450 scanning electron microscope (SEM). They are back-scatter electron images. 10 kgf Vickers' hardness indentation test was carried out on a Wilson VH1150 Macro Vickers Hardness Tester, the load was 10 kgf and the hold time was 10 s.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” can mean only one or can mean “one or more.” Embodiments of the inventions consistent with both constructions are covered.

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A method for the synthesis of an intermetallic alloy or a ceramic composite by additive manufacturing, the method comprising:
depositing a powder mixture on a substrate or passing a powder mixture through a nozzle, the powder mixture comprising:
at least one powder comprising a nitride compound; and
at least one additional powder comprising one or more additional elements of the intermetallic alloy or ceramic composite; and
directing a beam of energy onto the powder mixture to melt the powders, wherein the nitride compound and the one or more additional elements react in the melt to form the intermetallic alloy or ceramic composite, and further wherein the reaction releases heat that promotes powder melting and further reaction.

2. The method of claim 1, wherein the intermetallic alloy is a refractory metal intermetallic alloy.

3. The method of claim 1, wherein the nitride compound is Si₃N₄.

4. The method of claim 1, wherein N_{2(g)} is produced by the reaction.

5. The method of claim 1, wherein the intermetallic alloy or ceramic composite comprises at least two phases.

6. The method of claim 1, wherein the intermetallic alloy or ceramic composite comprises a ternary phase.

7. The method of claim 2, wherein the powder mixture comprises Si₃N₄ powder, Mo powder, and BN powder and the refractory metal intermetallic alloy comprises an intermetallic alloy of Moₛₛ and Mo₅SiB₂.

8. The method of claim 5, wherein the powder mixture comprises Si₃N₄ powder, B powder, and C powder and the ceramic composite comprises a BN phase and a SiC phase.

9. The method of claim 5, wherein the powder mixture comprises TiN powder, BN powder, and Fe powder and the intermetallic alloy comprises an Fess phase, a TiB₂ phase, an FeB phase, and an Fe₂B phase.

10. The method of claim 2, wherein the powder mixture comprises NbN powder, Si₃N₄ powder, and W powder and the refractory metal intermetallic alloy comprises an Nbₛₛ phase, a W₅Si₃ phase, a Nb₅Si₃ phase, and a NbSi₂ phase.

11. The method of claim 5, wherein the powder mixture comprises Si₃N₄ powder, AlN powder, and Fe powder and the intermetallic alloy comprises a Fess phase, a Fe₃Al₂Si₃ phase, and a FeSi phase.

12. A method for the synthesis of an intermetallic alloy or ceramic composite by additive manufacturing, the method comprising:
depositing a powder mixture on a substrate or passing a powder mixture through a nozzle, the powder mixture comprising:
at least one powder comprising a silicon carbide compound; and
at least one additional powder comprising one or more additional elements of the intermetallic alloy or ceramic composite; and
directing a beam of energy onto the powder mixture to melt the powders, wherein the silicon carbide compound and additional elements react in the melt to form the intermetallic alloy or ceramic composite, and further wherein the reaction releases heat that promotes powder melting and further reaction.

13. The method of claim 12, wherein the intermetallic alloy comprises a ternary alloy phase.

14. The method of claim 12, wherein the powder mixture comprises SiC powder, Ti powder, and C powder and the intermetallic alloy comprises a Tiₛₛ phase, a Ti₃SiC₂ phase and a SiC phase.

15. The method of claim 14, wherein the intermetallic alloy further comprises a TiC phase.

16. A method of forming a Mo—Si—B alloy that comprises a Moₛₛ phase and an intermetallic Mo₅SiB₂ phase and is substantially free of Mo₅Si₃, MoSi₃, and MoO₃ phases, the method comprising:
depositing a powder mixture on a substrate or passing a powder mixture through a nozzle, the powder mixture comprising:
Mo powder, Si₃N₄ powder and BN powder; or
Mo powder, Si powder, and B powder; and
directing a beam of energy onto the powder mixture to melt the powders, wherein the Mo powder, Si₃N₄ powder and BN powder or the Mo powder, Si powder, and B powder react in the melt to form the Mo—Si—B alloy, and further wherein the reaction releases heat that promotes powder melting and further reaction.
